(19) United States
(12) Patent Application Publication
(10) Pub. No.: US 2005/0216685 A1
(43) Pub. Date: Sep. 29, 2005

(54) Intelligent media storage system

(76) Inventors: Donald Gene Heden, Houston, TX (US); Richard Carl Tanner JR., Houston, TX (US)

Correspondence Address: Richard Carl Tanner, Jr., 13635 Mansfield Point Lane, Houston, TX, 77070, US

(21) Appl. No.: 11/043,620

(22) Filed: Jan. 26, 2005

Related U.S. Application Data
(60) Provisional application No. 60/541,291, filed on Feb. 3, 2004.

(51) Int. Cl. G06F 12/00

(52) U.S. Cl. 711/163

(57) ABSTRACT

The Intelligent Media Storage System disclosed herein protects computer programs and/or data files from being copied and used in an unauthorized manner. According to an example embodiment of the invention, an Intelligent Control Element (ICE) is installed between a computer system and a mass storage device. In a preferred embodiment, the ICE is disposed between a media storage device interface and the computer system interface. The ICE is responsible for writing data to and reading data from the protected mass storage devices of the IMSS. The ICE writes to and reads from the mass storage devices using special coding and encryption mechanisms. Each IMSS ICE uses different keys to code and encrypt data stored onto the mass storage device. Protected data is prepared for installation on an individual IMSS installed in one specific computer system, which is not usable by any other computer system (even when that other computer system is also equipped with another IMSS). In some embodiments, the mass storage interfaces are partitioned into separate protected and unprotected mass storage interfaces. In embodiments where associated interfaces are partitioned, the unprotected mass storage interfaces are controlled either directly by the system, or indirectly (as logical mass storage interfaces) by the ICE. In contrast, the protected mass storage interfaces are always physically restricted from being directly accessible from the system interface, and are generally controlled only by the ICE. The separation from direct system interface access provides a base level of piracy protection. In other embodiments, coding and encryption by the ICE of data stored onto protected mass storage connected to the IMSS provides another level of protection. The interface protocol implemented by the ICE is proprietary and is licensed only to software manufactures and distributors, which provides yet another level of protection. The use of standard mass storage read commands (i.e., non-IMSS ICE read commands) upon hard drives and devices written to by an IMSS will cause only coded and encrypted data from the protected mass storage device to be read. Although backup copies of the protected (i.e., coded and/or encrypted) files may be made, such copies are useless for any other purpose, as they will contain the coded/encrypted data that only the originating IMSS can decode or decipher. Thus, copies of protected programs and/or data files made for legitimate backup purposes cannot be used for any other purpose.

### STATEMENT OF RELATED APPLICATIONS

The instant application is a continuation-in-part of prior U.S. provisional application No. 60/541,291, filed Feb. 3, 2004.

### FIELD OF THE INVENTION

The present invention relates generally to security protocols for computer media storage and access systems, and, in a particular, non-limiting embodiment, to an intelligent media storage system in which computer software authentication and licensing processes are efficiently and logically integrated, and wherein piracy, deactivation and other security inconveniences are significantly avoided.

### BACKGROUND OF THE INVENTION

The present invention is drawn to methods and means by which computer media storage systems retrieve, execute, install and distribute programs and/or data files. Within this context, the term “computer media storage system” is defined as a device responsible for storage and retrieval of computer programs and/or data files. The term “computer program” is defined as any kind of executable computer program including (but not limited to) an operating system, a spreadsheet application, a word processor application, a computer game, shell scripts, compilers, linkers, etc. Finally, the term “data file” is intended to comprise any kind of computerized information including (but not limited to) JPEG picture image files, MP3 music files, MPEG movie files, databases, text files, etc.

Computer programs and/or data files are typically licensed for installation on a single computer (or in some cases, licensed for a specific number of installations on a specific limited number of computers). The computer programs and/or data files are generally provided to the licensee on distribution computer media. Examples of distribution computer media include Computer Disk Read Only Memory (CD-ROM) media, Digital Video Disk (DVD) media, USB FLASH ROM, Floppy diskette, PC-MCIA, FLASH ROM, etc. During the installation process, the computer program and/or data files are copied from the distribution media to the computer's mass storage system. The user is then enabled to subsequently retrieve the computer programs and/or data files from the storage system for execution or other licensed access.

A major shortcoming of the prevailing paradigm, however, is that purchasers and others can duplicate the computer programs and/or data files, and then install the programs and/or data files onto the storage systems of other computers contrary to the provisions of the purchaser's software license agreement.

Such program piracy is possible because hard drives have become easy to copy by use of widely available “ghost” programs. Moreover, both CD-ROM and DVD media have become easy to duplicate, either by moving the original CD-ROM/DVD media from one computer to another, or by duplicating the original CD-ROM/DVD and then moving the copies to other computers. Installed programs and/or data files can also be copied from a computer's offline storage system to another computer's storage system over a network connection, etc.

In an effort to reduce such piracy, several companies using CD-ROM, DVD, and/or floppy diskette media, etc., distribute their programs with associated key IDs and/or passwords. With key IDs and passwords, a user must properly enter (typically via the keyboard but other methods may be employed) the correct key ID or password before installation will occur. Those of ordinary skill in the art, however, will appreciate that keys and passwords are also easy to duplicate using photocopy machines, screen capture software, manually writing down important information, etc.

Other piracy-prevention methods involve having the installation program create a system fingerprint ID consisting of information specific to the end user's computer system. The fingerprint can include, for example, information about the system's motherboard, video cards, hard drives, etc. Once the fingerprint code is generated, the installer (or user) must then call the program manufacturer to report the serial number of the program being installed, along with the generated system fingerprint ID. The manufacturer then gives the installer a key that allows the installer to authenticate and complete the installation of the program. After installation, the computer program checks the system's fingerprint against the install time fingerprint to enable execution of the program on the computer. As no other computer will have the same exact fingerprint and the user will be uniquely registered with the manufacturer, piracy is reduced. In short, this protocol prevents the user from installing the same program on multiple systems, as they would have to contact the manufacturer for each installation. The drawbacks of this scheme, however, are that the user must contact the manufacturer each time the system hardware is updated or altered, since updating the system is likely to change the system's hardware fingerprint ID. Moreover, the user's personal privacy can be compromised when the user communicates their system resource information to the manufacturer.

Still other program security methods require a hardware device plugged onto either a serial or parallel port of the computer. While such devices are more difficult to duplicate than a user entered key ID or password, such fraud is not impossible. Moreover, those of skill in the pertinent arts can modify the application software after installation so as to ignore the requirement for the hardware device. Once the application software has been modified to ignore the hardware device, the program can again be easily copied, which would obviously render the program defenseless against piracy.

In view of the foregoing, it is clear there is a widespread need for devices and methods wherein software authentication and licensing processes are efficiently and logically integrated, and wherein piracy, deactivation and other security inconveniences are significantly avoided.

### SUMMARY OF THE INVENTION

An intelligent media storage and authentication system is provided, wherein the system comprises a mass storage device; an intelligent media storage and authentication device; and an associated computer system, wherein the intelligent media storage and authentication device is disposed in electronic communication with both the mass storage device and the associated computer system. Various storage and authentication devices are also disclosed, as well as a multi-tiered security protocol that flexibly permits users to allow or disallow program access to others as desired.

### BRIEF DESCRIPTION OF THE DRAWINGS

FIG. 1 is a block diagram of the IMSS system claimed herein.

FIG. 2 is a flow diagram of a PCI-to-IDE implementation protocol according to the invention.

FIG. 3 is a flow diagram of an USB-to-FLASH ROM implementation protocol according to the invention.

FIG. 4 is a raised side-view of an opened, top-hinged door disposed on a computer case for receiving an IMSS device as disclosed herein.

### DETAILED DESCRIPTION

The present invention provides an Intelligent Media Storage System (IMSS), wherein computer programs and/or data files are delivered to a computer system in which the IMSS is installed, so that the computer programs and/or data files are authenticated by the IMSS, thereby removing the burden of authenticating user access from both the computer system and associated verification software.

When properly employed by a software manufacturer or distributor, the computer program and/or data file installation process inexorably links one copy of a computer program and/or data file to an individual IMSS installed in an individual computer system. The IMSS in that computer then confirms that the computer programs and/or data files stored on the IMSS during the installation process are authenticated as accessed in the computer system, thereby ensuring that only a single copy of the licensed computer programs and/or data files can be running and/or accessed at a time.

The invention also permits a number of different computer programs and/or data files to be present on the IMSS, and ensures that computer programs and/or data files can be added or deleted, upgraded or downgraded, and/or backed up on the IMSS at any time (up to the maximum memory capacity of the particular IMSS).

In short, the invention provides for storage of computer programs and/or data files as with conventional storage devices, but with the added benefit of an efficient and foolproof license authentication protocol during the program fetch and retrieval process, wherein pirating techniques such as copying of distribution media, keys and passwords, hard drives, system fingerprinting, and other common privacy concerns are avoided. Once the computer programs and/or data files are installed on an IMSS as described below, the data cannot be copied in any manner that would later be functional on any other computer system.

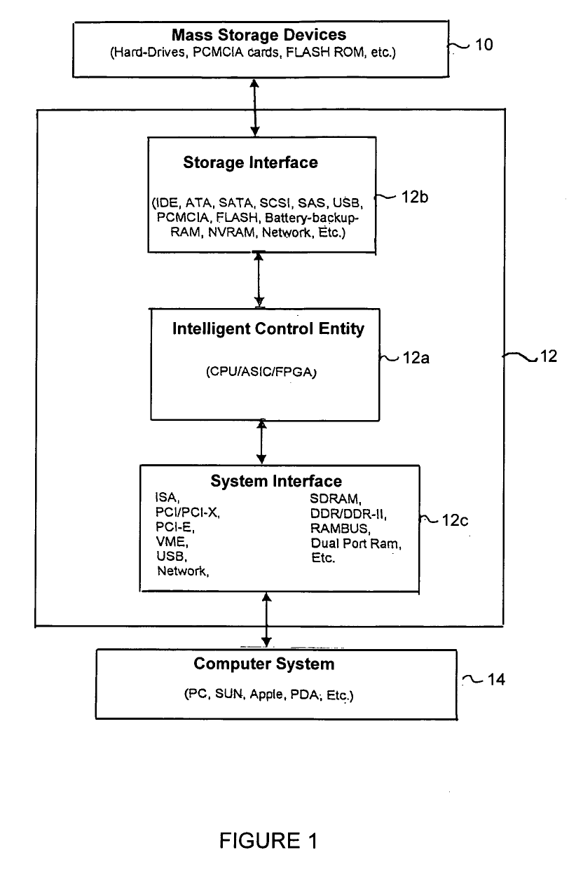

Referring now to the example embodiment of the invention depicted in FIG. 1, an intelligent media storage system according to the invention is provided comprising: a mass storage device 10 disposed in electronic communication with an associated computer system 14, wherein an intelligent media storage device 12 is disposed in electronic communication with each of said mass storage device 10 and said associated computer system 14. In a further embodiment, intelligent media storage device 12 further comprises an intelligent control entity (ICE) 12a, an ICE mass storage interface 12b, and an ICE system interface 12c. In a still further embodiment, ICE storage interface 12b is disposed in electronic communication with each of said mass storage device 10 and said ICE 12a, and ICE system interface 12c is disposed in electronic communication with each of said ICE 12a and an associated computer system 14.

In some embodiments, ICE system interface 12c further comprises a known system bus or interface member (e.g., an ISA, PCI/PCI-X, PCI-E, VME, USB, Network, etc.) and/or a physical device interface (e.g., a SD-RAM, DDR/DDR-II, RAMBUS, Dual Port Ram, etc.). In other embodiments, associated computer system 14 is only permitted access to the computer programs and/or data files stored on the IMSS via ICE system interface 12c.

In the example embodiment of FIG. 1, ICE 12a is ultimately responsible for the protection, access and distribution of all protected media files. In a presently preferred embodiment, ICE 12a responds to all existing storage media commands (e.g., read, write, seek, etc.), that any specific ICE system interface 12c will support, plus new commands responsible for writing and reading protected computer programs and/or data files to and from the mass storage media 10. Likewise, ICE storage interface 12b connects ICE 12a to an appropriate mass storage device 10 via an IDE, ATA, SATA, SCSI, SAS, USB, PC-MCIA, FLASH, Battery-backup-RAM, NVRAM, Ethernet, Internet, network, etc.

In practice, every IMSS ICE 12a has two essential functions, viz., (1) to provide normal mode media storage access to an associated computer system, and (2) to provide protected mode media storage access to an associated computer system.

Insofar as a “normal” mode media storage state is concerned, the associated computer system acts normally upon the non-protected areas of the mass media attached to the IMSS, and provides no special protection for either the mass storage resources or any of the computer programs and/or data files stored in the non-protected mass storage partition. Thus, execution of existing computer system commands (e.g., read, write, seek, etc.) on non-protected partitions of the mass storage media will cause a “normal” unprotected data read (or write) to or from the mass storage media attached to the IMSS.

However, when a partition is designated as a “protected” mode media storage memory, the IMSS will provide read/write protection for all of the computer programs and/or data files stored in the partition. For example, any attempt to execute an existing computer system's read commands (e.g., read, seek, etc.) from the protected regions of the mass storage media causes raw, unusable, coded and/or encrypted data to be read. When data is protected, only the new IMSS command protocol will enable file activity (e.g., file creation, data coding and encryption, etc.) within the protected memory partitions.

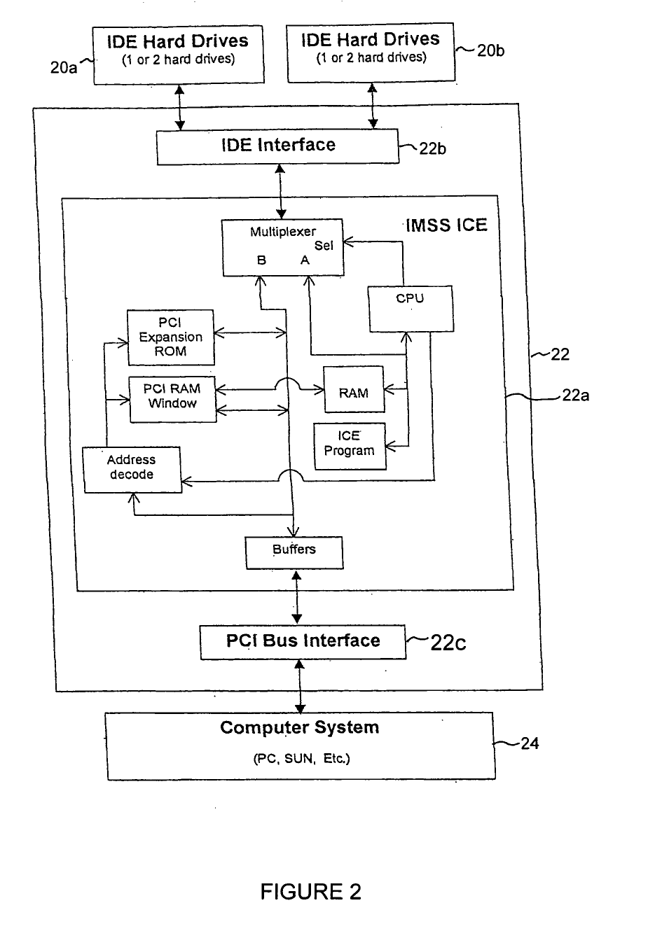

Referring to the non-limiting embodiment depicted in FIG. 2, those of skill in the pertinent arts will appreciate that when an intelligent media storage and authentication device 24 is designed as a PCI bus-to-IDE hard drive interface card, the card will admit to operation in one of at least three discrete operational modes, viz., (1) a full protection operational mode, wherein all of the IDE hard-drive interfaces 22b on the card are configured to operate in the protected media storage mode; (2) a partial protection operational mode, wherein one or more of IDE interfaces 22b are configured to operate in the protected media storage mode, while at least one of the IDE interfaces 22b is configured to operate in the normal media storage mode; and (3) a non-protection operational mode, wherein none of the IDE interfaces 22b are configured to operate in a protected media storage mode, but instead are set in a normal media storage mode.

While in the full protection operational mode, the IDE interfaces 22b are hidden from the computer system 24, and all access to the protected mode interfaces must pass through an ICE interface 22a. Thus, in the full protection operational mode, a proprietary command set must be used to store or retrieve any meaningful data to or from the media storage devices hidden behind the ICE interface 22a.

In a partial protection operational mode, a logical configuration protocol determines which specific IDE interfaces 22b and/or interfaced physical drives 20a and 20b are partitioned in a protected operational mode. Those interfaces 22b and/or hard drives 20a and 20b that are not partitioned in a protected mode are instead disposed in a normal access mode, wherein conventional computer commands will enable the data storage and retrieval process without inhibition.

In a non-protection operational mode, the IDE interfaces 22b appear to the system as standard IDE interfaces, and are compliant with existing IDE interfaces already known to those of skill in the art. In a presently preferred embodiment, it is contemplated that existing IDE software drivers are used to store and retrieve data to and from the media devices 20a and 20b attached to the IDE interfaces 22b. In the preferred embodiment, the ICE 22a is not required to interface the media devices; accordingly, no read or write protection whatsoever is enabled when the device is operating in a non-protection operational mode. Should the IMSS card be re-configured to again include some protected mass storage, the ICE 22a will again hide at least one of the IDE interfaces 22b, so as to provide appropriate protection for the newly partitioned protected data.

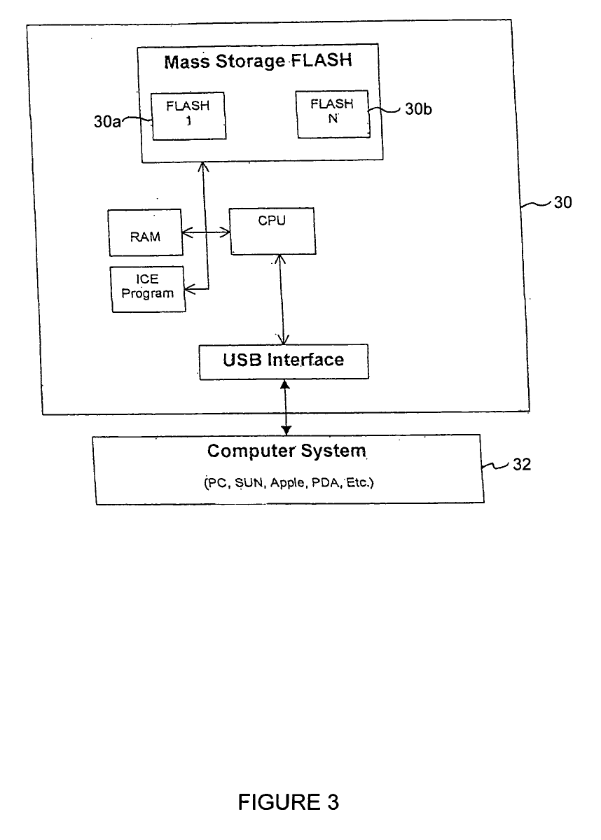

Similarly (and as seen in the example embodiment of FIG. 3), when the intelligent media storage and authentication device 30 is designed as a USB FLASH storage device, the configuration protocol again permits the USB device to operate in one of three discrete operational modes, viz., (1) a full protection operational mode, wherein all of the FLASH devices on the USB device are configured to operate in a protected media storage mode; (2) a partial protection mode, wherein one or more FLASH devices 30a and 30b are configured to operate in a protected media storage mode, while at least one of the remaining flash devices 30a and 30b are configured to operate in a non-protected media storage mode; and (3) a non-protection operational mode, wherein none of the FLASH devices 30a and 30b are configured to operate in a protected mode.

In the context of the invention as depicted in FIG. 3, the terms “full protection operational mode,” “partial protection operational mode,” and “non-protection operational mode” are defined as above with respect to the example embodiment depicted in FIG. 2.

In short, differing levels of system protection are available because various interfaces can be physically disconnected from the system bus, and therefore cannot be directly manipulated by any means in order to make illegitimate copies of the data stored on the media. In this manner, protected data is hidden from direct system access, and can only be accessed by an undocumented, proprietary command set issued by the system (or the system owner) directly to the ICE card.

Moreover, each of the mass storage resources (e.g., hard-drives, PC-MCIA FLASH cards, FLASH integrated circuit chip, etc.), or each partition of the storage resources, that is configured for protected modes of operation have encrypted data stored on that particular resource (or partition). In a presently preferred embodiment, the encryption key is linked to the serial number of the ICE, and only that specific ICE controller contains the encryption key.

Thus, once the ICE has initialized functionality of the IMSS, the computer programs and/or data files stored on the protected mass storage resources are incapable of being deciphered and used when attached to another IMSS's protected or unprotected interface. If such access is attempted, the unauthorized user will derive no meaningful data or operational information from the incompatible host machine. Although a copy from a mass storage element to another mass storage element can be done for backup purposes, the copied data is still encrypted, and can only be unencrypted and deciphered by the original controller on which it was originally stored or by which it was originally created.

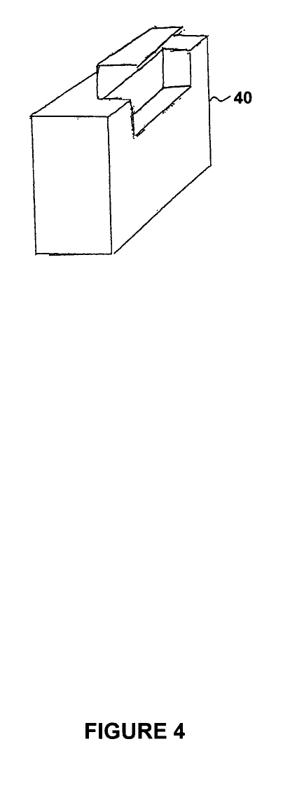

In one example system initialization, an IMSS adapter is created for installation in a PC-compatible system. An end user purchases the IMSS card from a vendor, installs it as a secondary (non-booting) storage controller, and then attaches one or more hard-drives. When the PC is turned on, a configuration protocol is executed to instruct the ICE controller how to partition the hard drives that have been attached to the adapter. Again, one or more of the associated devices can be set in the full protection, partial protection and non-protection operational modes. In this embodiment, it may be convenient to dispose the IMSS in an integrated cardholder prior to initialization, for example, the cardholder depicted in FIG. 4.

In a further example system initialization, a computer system motherboard manufacturer creates an IMSS circuit that is either fabricated or installed directly onto the motherboard. An end user (or a distributor) then purchases one or more motherboards equipped with the IMSS from the manufacturer, integrates the motherboard with a cabinet, power-supply, hard-drives, etc., thereby creating a complete computer system. When the system's power supply is turned on, a configuration protocol is executed to instruct the ICE controller which, if any, of the media storage devices will be protected. In many embodiments, the end user (or distributor) will configure the IMSS and install programs and data files as desired, storing some in the protected regions of the mass storage partitions, while other data remains freely available in the unprotected regions of the mass storage partitions.

In a still further example system initialization, a computer system equipped with an IMSS is configured so that each of a CD-ROM drive and a normal hard-drive attached to the IMSS card is protected. The owner of the computer system purchases software from a company that distributes software supporting the IMSS installation protocol, and communicates the IMSS serial number to the company at the time of purchase. The software distribution company then creates either a CD-ROM disk and mails it to the purchaser, or a CD-ROM image file and e-mails the image to the purchaser (or otherwise allows the CD-ROM image or file set to be downloaded by the purchaser for burning onto a CD-ROM disk). The CD-ROM is created so that the programs and/or data files on the CD-ROM are readable only by the IMSS with which it was created for use.

After the purchaser has the CD-ROM disk in hand, that CD-ROM disk (and any copy) is useful only when accessed by the IMSS in the purchaser's computer system. When placed in the CD-ROM drive attached to the IMSS, the installation program (or any other program and/or data placed on it by the authorized software distributor) is accessible and usable only via the IMSS. When the CD-ROM disk is placed in a CD-ROM drive not attached to the specific IMSS for which it was created, the computer programs and/or data files on the CD-ROM will not be accessible or usable by the unauthorized user.

The claimed invention also admits to additional levels of security in that the protocols described above can be combined with other techniques so as to layer security efforts in particularly sensitive environments. For example, in some embodiments it is necessary to insert an IMSS intelligent media card into a computer terminal before the terminal can be booted up, or before a given user can sign in and use the terminal, etc. In other embodiments (particularly in WiFi or other wireless applications), it is necessary for a remote terminal to send a radio frequency signal or an infrared signal to a host machine before boot up or sign in can commence at the remote terminal; in some embodiments, it is required that the disclosed intelligent media card be inserted before the remote terminal will initiate transmission of an appropriate introductory signal.

The foregoing specification is provided for illustrative purposes only, and is not intended to describe all possible aspects of the present invention. Moreover, while the invention has been shown and described in detail with respect to several exemplary embodiments, those of ordinary skill in the pertinent arts will appreciate that minor changes to the description, and various other modifications, omissions and additions may also be made without departing from either the spirit or scope thereof.

1. An intelligent media storage and authentication system, the system comprising:
a mass storage device;
an intelligent media storage and authentication device; and
an associated computer system,
wherein said intelligent media storage and authentication device is disposed in electronic communication with each of said mass storage device and said associated computer system.

2. The intelligent media storage and authentication system of claim 1, wherein said intelligent media storage and authentication device further comprises an intelligent control entity.

3. The intelligent media storage and authentication system of claim 2, wherein said intelligent media storage and authentication device further comprises a storage interface for interfacing said intelligent control entity and said mass storage device.

4. The intelligent media storage and authentication system of claim 2, wherein said intelligent media storage and authentication device further comprises a system interface for interfacing said intelligent control entity and said associated computer system.

5. The intelligent media storage and authentication system of claim 1, wherein said intelligent media storage and authentication device further comprises an intelligent control entity, a storage interface for interfacing said intelligent control entity and said mass storage device, and a system interface for interfacing said intelligent control entity and said associated computer system.

6. The intelligent media storage and authentication system of claim 5, wherein said intelligent media storage and authentication device further comprises at least three discrete operational modes.

7. The intelligent media storage and authentication system of claim 6, wherein at least one of said three discrete operational modes comprises a full protection operational mode.

8. The intelligent media storage and authentication system of claim 6, wherein at least one of said three discrete operational modes comprises a partial protection operational mode.

9. The intelligent media storage and authentication system of claim 6, wherein at least one of said three discrete operational modes comprises a non-protection operational mode.

10. The intelligent media storage and authentication system of claim 6, wherein said three discrete operational modes comprises at least a full protection operational mode, a partial protection operational mode, and a non-protection operational mode.

11. The intelligent media storage and authentication system of claim 1, wherein said mass storage device further comprises one or more of a hard drive, an IDE hard drive, an external memory unit, a CD, a DVD, a PC-MCIA card, and a FLASH ROM.

12. The intelligent media storage and authentication system of claim 5, wherein said storage interface for interfacing said intelligent control entity and said mass storage device further comprises one or more of an IDE device, an ATA device, a SATA device, a SCSI device, a SAS device, a USB device, a PC-MCIA device, a FLASH device, a battery-backup RAM device, a NV-RAM device, a network device, and an Ethernet device.

13. The intelligent media storage and authentication system of claim 5, wherein said system interface for interfacing said intelligent control entity and said associated computer system further comprises one or more of a system interface member and a system device member.

14. The intelligent media storage and authentication system of claim 13, wherein said system interface member further comprises one or more of an ISA interface member, a PCI interface member, a PCI-X interface member, a PCI-E interface member, a VME interface member, a USB interface member, an Internet browser interface member an Ethernet interface member, and a network interface member.

15. The intelligent media storage and authentication system of claim 13, wherein said system device member further comprises one or more of a SD-RAM system device member, a DDR system device member, a DDR-II system device member, a RAMBUS system device member, and a dual port RAM system device member.
